(19) United States
(12) Patent Application Publication
(10) Pub. No.: US 2026/0153355 A1
(43) Pub. Date: Jun. 4, 2026

(54) TRACKING SYSTEM AND METHOD

(71) Applicant: HTC Corporation, Taoyuan City (TW)

(72) Inventors: Yu-Tzu WANG, Taoyuan City (TW); Sheng-Hui TAO, Taoyuan City (TW)

(21) Appl. No.: 18/967,687

(22) Filed: Dec. 4, 2024

(51) Int. Cl. G01C 21/00

(52) U.S. Cl. CPC G01C 21/3889

(57) ABSTRACT

A tracking system and method are provided. The at least one electronic device of the tracking system selects a range map data from a spatial map information based on an initial position configuration. The at least one electronic device loads the range map data into a memory space of the at least one electronic device. The at least one electronic device performs a relocalization operation based on the range map data in the memory space. In response to completing of the relocalization operation, the at least one electronic device initiates a tracking operation corresponding to the at least one electronic device.

### BACKGROUND

### Field of Invention

The present invention relates to a tracking system and method. More particularly, the present invention relates to a tracking system and method that can improve tracking operation efficiency.

### Description of Related Art

In recent years, various technologies related to virtual reality have developed rapidly, and various technologies and applications of electronic devices have been proposed one after another.

In the prior art, since the electronic device (e.g., the head-mounted display, the tracking device, etc.) needs to process map information in the entire environmental space, the spatial map information stored in the storage of the electronic device is usually quite large.

However, in a large-scale map environment, if all the spatial map information stored by the electronic device is loaded into the memory, it may cause a huge resource burden on the memory of the electronic device and reduce the efficiency of positioning and tracking operation.

Accordingly, there is an urgent need for a tracking technology that can improve the efficiency of tracking operations.

### SUMMARY

An objective of the present disclosure is to provide a tracking system. The tracking system comprises at least one electronic device. Each of the at least one electronic device is configured to store a spatial map information. The at least one electronic device selects a range map data from the spatial map information based on an initial position configuration, wherein the range map data is a part of the spatial map information. The at least one electronic device loads the range map data into a memory space of the at least one electronic device. The at least one electronic device performs a relocalization operation based on the range map data in the memory space. In response to completing the relocalization operation, the at least one electronic device initiates a tracking operation corresponding to the at least one electronic device.

Another objective of the present disclosure is to provide a tracking method, which is adapted for use in a tracking system. The tracking system comprises at least one electronic device. Each of the at least one electronic device is configured to store a spatial map information. The tracking method comprises following steps: selecting a range map data from the spatial map information based on an initial position configuration, wherein the range map data is a part of the spatial map information; loading the range map data into a memory space of the at least one electronic device; performing a relocalization operation based on the range map data in the memory space; and in response to completing the relocalization operation, initiating a tracking operation corresponding to the at least one electronic device.

According to the above descriptions, the tracking technology (at least including the system and the method) provided by the present disclosure, by pre-defining the initial position configuration, the electronic device can select the range map data from the spatial map information to load the range map data into the memory space of the electronic device. Then, the electronic device performs a relocalization operation based on the range map data in the memory space. Since the present disclosure does not need to load all spatial map information into the memory, it solves the problem of memory resource burden in the prior art. In addition, since the content of map data that needs to be compared is reduced, the efficiency of relocalization operations and tracking operations can be improved. In addition, the tracking technology provided by the present disclosure can reduce the memory resource usage of the electronic device and improve the efficiency of resource utilization.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1A is a schematic view depicting a tracking system of the first embodiment;

FIG. 1B is a schematic view depicting a tracking system of some embodiments;

FIG. 2 is a schematic view depicting an electronic device of some embodiments;

FIG. 3 is a schematic view depicting a central monitoring device of some embodiments;

FIG. 4 is a schematic view depicting a spatial map of some embodiments;

FIG. 5 is a schematic view depicting a spatial map of some embodiments; and

FIG. 6 is a partial flowchart depicting a tracking method of the second embodiment.

### DETAILED DESCRIPTION

In the following description, a tracking system and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

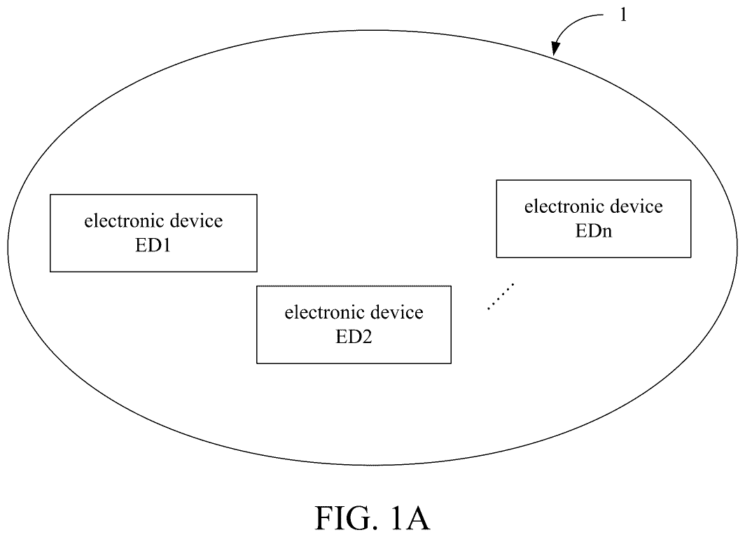

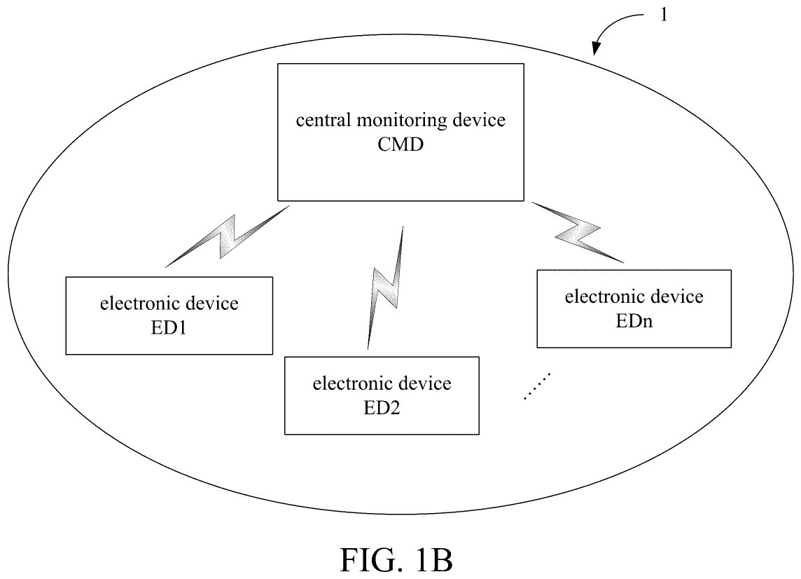

First, an application scenario of this embodiment is described, and a schematic diagram is depicted in FIG. 1A. In the first embodiment of the present disclosure, the tracking system 1 comprises at least one electronic device, for example: as shown in FIG. 1A, the tracking system 1 comprises a plurality of electronic devices ED1, ED2, . . . , EDn, where n is a positive integer.

It shall be appreciated that, in the scene disclosed in the present disclosure, multiple users can wear electronic devices ED1, ED2, . . . , EDn respectively to perform interactive operations in the scene. For example, the electronic device can be a head-mounted display (HMD) or a tracking device used by the user.

In some embodiments, as shown in FIG. 1B, the tracking system 1 may further comprise a central monitoring device CMD, and the central monitoring device CMD is communicatively connected to the electronic devices ED1, ED2, . . . , EDn. Specifically, the central monitoring device CMD can be connected to the electronic device through a wired network or a wireless network.

It shall be appreciated that the central monitoring device CMD can be configured to monitor the positions of each of the electronic devices ED1, ED2, . . . , EDn on the map. For example, the central monitoring device CMD can receive external data such as images, sensing data, etc. through external devices (e.g., sensors installed in the environment), and monitor the position of each of the electronic devices ED1, ED2, . . . , EDn on the map.

In some embodiments, the central monitoring device CMD may be configured to monitor a tracking states of each of the electronic devices ED1, ED2, . . . , EDn. For example, the electronic devices ED1, ED2, . . . , EDn continuously generate tracking trajectory-related data (e.g., at a frequency of 5 times per second), and transmit the tracking trajectory-related data to the central monitoring device CMD.

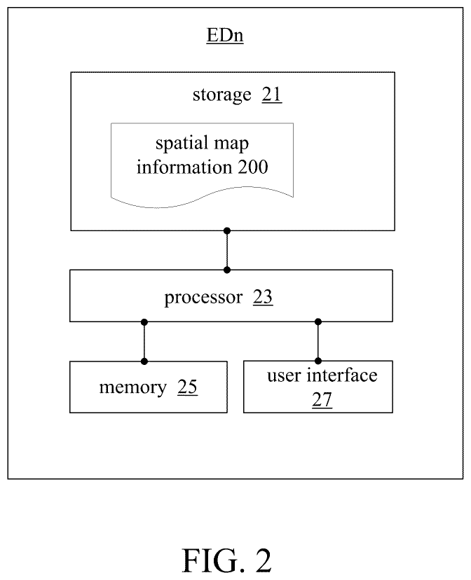

In some embodiments, a schematic view of components of the electronic device HMD is shown in FIG. 2 (taking the electronic device EDn as an example). The electronic device EDn may comprise at least a storage 21, a processor 23, and a memory 25. The processor 23 is electrically connected to the storage 21 and the memory 25. In some embodiments, the electronic device EDn may further comprise a user interface 27, and the processor 23 is electrically connected to the user interface 27. The user can set related settings of the electronic device EDn through the user interface 27.

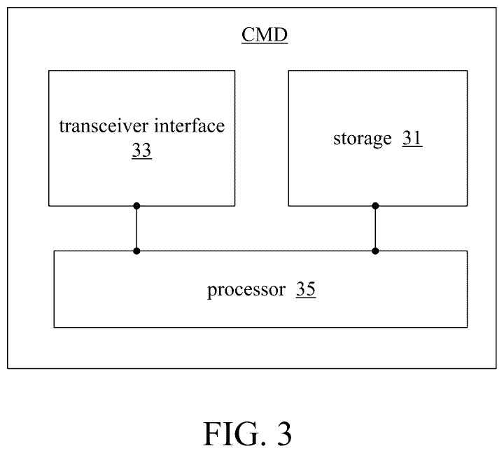

In some embodiments, a schematic view of components of the central monitoring device CMD is shown in FIG. 3. The central monitoring device CMD may at least comprise a storage 31, a transceiver interface 33, and a processor 35, and the processor 35 is electrically connected to the storage 31 and the transceiver interface 33.

It shall be appreciated that the storage 21 and the storage 31 may be a Universal Serial Bus (USB) disk, a hard disk, a Compact Disk (CD), a mobile disk, or any other storage medium or circuit known to those of ordinary skill in the art and having the same functionality. The processor 23 and the processor 35 may be any of various processors, Central Processing Units (CPUs), microprocessors, digital signal processors or other computing apparatuses known to those of ordinary skill in the art. The memory 25 may be any storage medium or circuit capable of serving as a short-term data storage area for the processor. The transceiver interface 33 is an interface capable of receiving and transmitting data or other interfaces capable of receiving and transmitting data and known to those of ordinary skill in the art. The user interface 27 can be any device that can interact with the user.

It shall be appreciated that the aforementioned FIG. 2 and FIG. 3 only illustrate the components of the electronic device EDn and the central monitoring device CMD related to the operations of the present invention. It shall be appreciated that during actual operations, the electronic device EDn and the central monitoring device CMD may still include other components necessary for operations (e.g., image capturers, display screens and other transceiver interfaces).

In the present embodiment, the electronic devices ED1, ED2, . . . , EDn store a spatial map information 200. Specifically, the spatial map information 200 may be spatial map information generated by the electronic devices ED1, ED2, . . . , EDn based on simultaneous localization and mapping (SLAM).

In some embodiments, the spatial map information 200 may comprise at least one of a feature point, a key frame, a point cloud information, a corner point information of an object, and a position information corresponding to a feature target in the space or a combination thereof.

In some embodiments, the spatial map information 200 is generated by the central monitoring device CMD after integrating the map information. For example, the central monitoring device CMD receives partial spatial map information from the electronic devices ED1, ED2, . . . , EDn (For example: sub-areas in the scene). Then, the central monitoring device CMD generates the spatial map information 200 based on the partial map information. Finally, the central monitoring device CMD transmits the spatial map information 200 to the electronic devices ED1, ED2, . . . , EDn for storage.

For ease of understanding, the following description will take the electronic device EDn as an example, and other electronic devices can also perform the same operation.

In the present embodiment, the electronic device EDn can select map data of a partial area from the entire map based on a preset initial position configuration. Specifically, the electronic device EDn selects a range map data from the spatial map information based on an initial position configuration, and the range map data is a part of the spatial map information.

It shall be appreciated that the initial position configuration can be updated and generated according to different application scenarios of the electronic device. For example, the initial position configuration can be generated in advance by a third-party device and then stored in each electronic device. For another example, the initial position configuration can be regularly transmitted to each electronic device for updates by the central monitoring device CMD based on changes in the map scene or adjustments to the application scenario.

For example, the initial position configuration may comprise a plurality of initial positions (e.g., the centralized starting position of the electronic devices, the borrowed position of the electronic devices, the entrance position of the area). In some embodiments, different initial position configurations can be stored for different groups of electronic devices.

In some embodiments, the electronic device can update and determine the initial position configuration through another electronic device. For example, when the user wears a head-mounted display and a tracking device at the same time, after the head-mounted display determines the position, the tracking device can directly receive initial position-related information (such as initial position configuration) from the head-mounted display.

In some embodiments, the electronic device may be configured as a host device or a slave device in advance. The host device first updates and determines the initial position configuration, and the slave device can directly receive the initial position related information from the host device. For example, when the user wears tracking devices located on the arms, waist, and feet at the same time, the tracking device located on the waist can first update and determine the initial position configuration. Then, the tracking device located on the waist transmits the information to tracking devices located in other parts of the body to save the consumption of computing resources.

In some embodiments, the initial position configuration comprises at least one initial position, a position coordinate and a loading range of each of the at least one initial position. In some embodiments, the loading range may be determined by a hardware resource level of each of the at least one electronic device.

In some embodiments, the electronic device EDn selects the range map data from the spatial map information based on the position coordinate and the loading range of each of the at least one initial position. For example, when the visible range of the electronic device is 10 meters, the loading range of the map can be set to a distance range extending 10 meters or less from the location coordinates.

In some embodiments, the initial position configuration may comprise a preset facing direction corresponding to each initial position (for example: facing east at a 30-degree angle). When the electronic device starts operating in this position, tracking will start in the default facing direction.

In some embodiments, the electronic device EDn can determine the initial position through positioning information. For example, when the electronic device EDn is determined to be located in the first area, the electronic device EDn can start the tracking operation from the initial position corresponding to the first area. When the electronic device EDn determines that it is located in the second area, the electronic device EDn can start the tracking operation from the initial position corresponding to the second area.

Specifically, the initial position configuration comprises at least one initial position, and a position coordinate, an initial orientation, and a loading range of each of the at least one initial position. The electronic device EDn determines a first initial position from the at least one initial position based on a positioning information of the at least one electronic device. Then, the electronic device EDn initiates the tracking operation corresponding to the at least one electronic device based on the position coordinate, the initial orientation, and the loading range of the first initial position.

Next, in the present embodiment, the electronic device EDn can only load the map data of a partial area (such as the aforementioned initial position and loading range) through the default configuration. Specifically, the electronic device EDn loads the range map data into a memory space of the at least one electronic device.

Next, in the present embodiment, the electronic device EDn performs a relocalization operation based on the range map data in the memory space. Finally, in the present embodiment, in response to completing the relocalization operation, the electronic device EDn initiates a tracking operation corresponding to the electronic device EDn.

For example, the electronic device EDn can perform the relocalization operation by comparing a plurality of feature targets and real-time images corresponding to the range map data. It shall be appreciated that each of these feature targets comprises at least one of a key frame, a key point or a combination thereof.

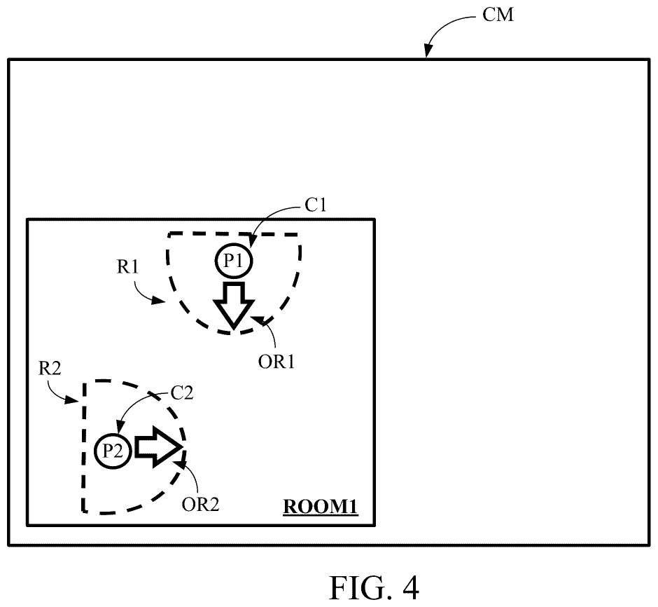

For ease of understanding, please refer to the schematic diagram of the spatial map in FIG. 4. The spatial map CM corresponds to all spatial ranges in the spatial map information 200. In the present example, the spatial map CM includes the spatial area ROOM1 and the initial positions P1 and P2 located in the spatial area ROOM1. The initial position P1 includes a position coordinate C1, an initial orientation OR1, and a loading range R1. The initial position P2 includes a position coordinate C2, an initial orientation OR2, and a loading range R2.

In the present example, the loading range R1 and the loading range R2 can be a semicircular area extended by the position coordinates C1 and C2.

In the present example, the electronic device EDn can load both the loading range R1 and the loading range R2 into the memory space. In the present example, the electronic device EDn performs a relocalization operation based on the loading range R1 and the loading range R2. After the electronic device EDn is positioned to the initial position P1, the electronic device EDn may initiate the subsequent tracking operation with the settings of the position coordinate C1, the initial orientation OR1, and the loading range R1.

It shall be appreciated that since only part of the range map data is loaded into the memory space, and the electronic device EDn only needs to compare the range map data, the efficiency of the relocalization operation can be improved and the memory resource usage of the electronic device can be reduced.

In some embodiments, the tracking system of the present disclosure can assign different character categories and initial orientations based on different application scenarios. For example, in an application scenario where users play the roles of a policeman and a thief, electronic devices corresponding to different character categories can be assigned to different initial orientations.

Specifically, the initial position configuration further comprises a plurality of character categories corresponding to each of the at least one initial position and a first initial orientation and a second initial orientation corresponding to the plurality of character categories. The at least one electronic device corresponding to a first character category initiates the tracking operation based on the first initial orientation. In addition, the at least one electronic device corresponding to a second character category initiates the tracking operation based on the second initial orientation, and the first initial orientation is different from the second initial orientation.

In some embodiments, each character category may be related to the initial position of the electronic device. For example, a plurality of initial positions located in a specific area are classified into a first character category, and other initial positions in non-specific areas are classified into a second character category.

In some embodiments, the electronic device can actively adjust/set all information in the initial position configuration (such as initial orientation, character category) through the user interface 27.

In some embodiments, as shown in FIG. 1B, the tracking system 1 further comprises a central monitoring device CMD, and the central monitoring device CMD is configured to monitor a tracking status of each of the at least one electronic device. In addition, the electronic device receives the initial position configuration from the central monitoring device CMD to select the range map data from the spatial map information.

In some embodiments, the central monitoring device CMD may adjust the content of the spatial map information 200 due to changes in the environment, and the central monitoring device CMD may transmit the adjusted spatial map information 200 to the electronic devices ED1, ED2, . . . , EDn. For example, the central monitoring device CMD can periodically (for example, once every 5 minutes) transmit the spatial map information 200 to the electronic devices ED1, ED2, . . . , EDn to update the spatial map information 200 stored in the storage 21 of the electronic devices ED1, ED2, . . . , EDn.

In some embodiments, when the electronic device loses tracking, the central monitoring device CMD can transmit the location information of the electronic device and surrounding map data to assist the electronic device in quickly repositioning. Specifically, the central monitoring device CMD determines whether an electronic device (hereinafter referred to as: the first electronic device) of the at least one electronic device loses tracking. Then, in response to the first electronic device losing tracking, the central monitoring device CMD determines a current position of the first electronic device. Finally, the central monitoring device CMD transmits an auxiliary map data corresponding to the current position to the first electronic device.

In some embodiments, the electronic device that has lost tracking (i.e., the first electronic device) selects an update range map data from the spatial map information based on the auxiliary map data. Then, the first electronic device loads the updated range map data into the memory space of the first electronic device. Finally, the first electronic device performs the relocalization operation based on the updated range map data in the memory space.

In some embodiments, when the electronic device is located at the boundary of areas (for example: area entrances and exits, elevator areas, stair areas, etc.), the central monitoring device CMD can actively transmit the configuration of the next area to speed up repositioning operations for electronic devices. Specifically, the central monitoring device CMD tracks a current position of the at least one electronic device. Then, in response to the current position of a second electronic device being in a switching position of a first area, the central monitoring device CMD transmits a switching position configuration corresponding to a second area to the second electronic device to make the second electronic device perform the relocalization operation based on the switching position configuration.

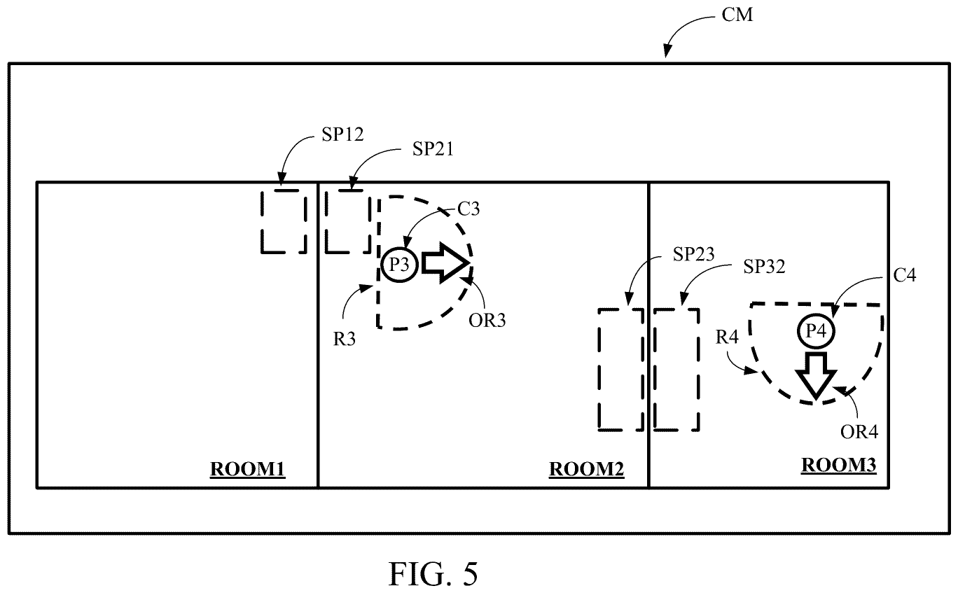

For ease of understanding, please refer to the schematic diagram of the spatial map in FIG. 5. The spatial map CM corresponds to all spatial ranges in the spatial map information 200. In the present example, the spatial map CM includes spatial area ROOM1, spatial area ROOM2, and spatial area ROOM3. In the present example, the spatial area ROOM1 includes a switching position SP12, the spatial area ROOM2 includes a switching position SP21 and a switching position SP23, and the spatial area ROOM3 includes a switching position SP32. In the present example, in response to the electronic device being located at the switching position SP12 of the spatial area ROOM1, the central monitoring device CMD transmits the switching position configuration of the spatial area ROOM2 to the electronic device (i.e., the initial position P3 includes a position coordinate C3, an initial orientation OR3, and a loading range R3) to make the electronic device perform the relocalization operation based on the switching position configuration.

In the present example, in response to the electronic device being located at the switching position SP23 of the spatial area ROOM2, the central monitoring device CMD transmits the switching position configuration of the spatial area ROOM3 to the electronic device (i.e., the initial position P4 includes a position coordinate C4, an initial orientation OR4, and a loading range R4) to make the electronic device perform the relocalization operation based on the switching position configuration.

In some embodiments, when there are too many devices in the target area, the loading range can be increased to reduce the impact of sight occlusion on the relocalization operation. Specifically, the initial position configuration comprises at least one initial position, and a position coordinate, an initial orientation, and a loading range of each of the at least one initial position. The central monitoring device CMD calculates a device amount of the at least one electronic device located in a target area. Then, in response to the device amount being greater than a preset value, the central monitoring device CMD adjusts the loading range of each of the at least one initial position in the target area.

In some embodiments, the electronic device can communicate with nearby devices (for example: other electronic devices) through wireless communication to calculate the number of devices within the target range (for example: 10 meters). In addition, when there are too many devices in the target range, the loading range can be increased to reduce the impact of sight occlusion on the relocalization operation. Specifically, the electronic device calculates a device amount of the at least one electronic device located in a target range. Then, in response to the device amount being greater than a preset value, the electronic device adjusts the loading range.

In some embodiments, the electronic device can dynamically adjust the content loaded into the memory 25 based on changes in character category/environment. For example, the electronic device receives a new character category (e.g., a second character category) from the central monitoring device CMD. Then, each of the electronic devices adjusts the content loaded into the memory 25 based on the new character category.

According to the above descriptions, the tracking system 1 provided by the present disclosure, by pre-defining the initial position configuration, the electronic device can select the range map data from the spatial map information to load the range map data into the memory space of the electronic device. Then, the electronic device performs a relocalization operation based on the range map data in the memory space. Since the present disclosure does not need to load all spatial map information into the memory, it solves the problem of memory resource burden in the prior art. In addition, since the content of map data that needs to be compared is reduced, the efficiency of relocalization operations and tracking operations can be improved. In addition, the tracking system 1 provided by the present disclosure can reduce the memory resource usage of the electronic device and improve the efficiency of resource utilization.

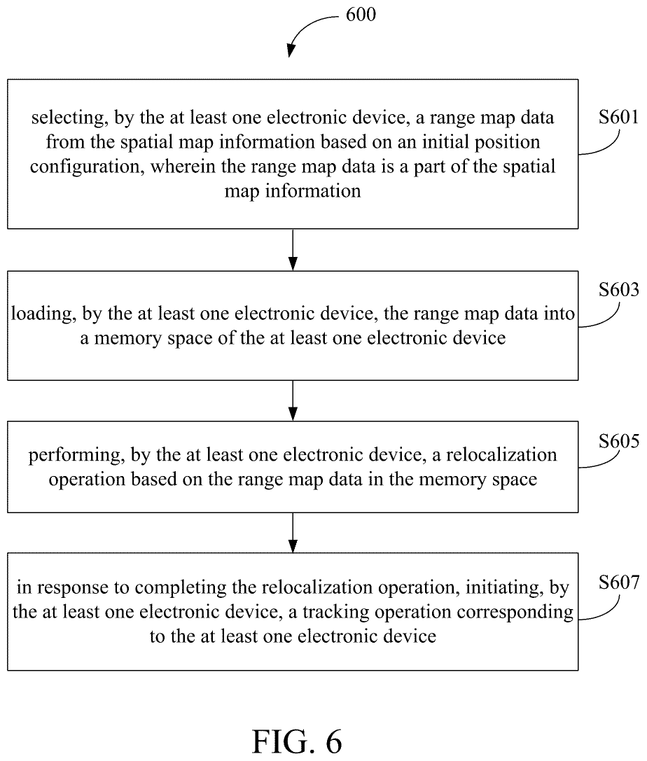

A second embodiment of the present disclosure is a tracking method and a flowchart thereof is depicted in FIG. 6. The tracking method 600 is adapted for a tracking system (e.g., the tracking system 1 of the first embodiment). The tracking system comprises at least one electronic device (e.g., the electronic device ED1, ED2, . . . , EDn of the first embodiment). Each of the at least one electronic device is configured to store a spatial map information (e.g., the spatial map information 200 of the first embodiment). The tracking method 600 initiates a tracking operation through steps S601 to S607.

In the step S601, the at least one electronic device selects a range map data from the spatial map information based on an initial position configuration, wherein the range map data is a part of the spatial map information. Next, in the step S603, the at least one electronic device loads the range map data into a memory space of the at least one electronic device.

Next, in the step S605, the at least one electronic device performs a relocalization operation based on the range map data in the memory space.

Finally, in the step S607, in response to completing the relocalization operation, the at least one electronic device initiates a tracking operation corresponding to the at least one electronic device.

In some embodiments, the initial position configuration comprises at least one initial position, a position coordinate and a loading range of each of the at least one initial position, and the step of selecting the range map data further comprises the following steps: selecting the range map data from the spatial map information based on the position coordinate and the loading range of each of the at least one initial position.

In some embodiments, the initial position configuration comprises at least one initial position, and a position coordinate, an initial orientation, and a loading range of each of the at least one initial position, and the step of initiating the tracking operation corresponding to the at least one electronic device further comprises the following steps: determining a first initial position from the at least one initial position based on a positioning information of the at least one electronic device; and initiating the tracking operation corresponding to the at least one electronic device based on the position coordinate, the initial orientation, and the loading range of the first initial position.

In some embodiments, the initial position configuration further comprises a plurality of character categories corresponding to each of the at least one initial position and a first initial orientation and a second initial orientation corresponding to the plurality of character categories, and the tracking method 600 further comprises the following steps: initiating the tracking operation based on the first initial orientation by the at least one electronic device corresponding to a first character category; and initiating the tracking operation based on the second initial orientation by the at least one electronic device corresponding to a second character category; wherein the first initial orientation is different from the second initial orientation.

In some embodiments, the tracking system further comprises a central monitoring device, the central monitoring device is communicatively connected to the at least one electronic device, the central monitoring device is configured to monitor a tracking status of each of the at least one electronic device, and the tracking method 600 further comprises the following steps: receiving, by the at least one electronic device, the initial position configuration from the central monitoring device to select the range map data from the spatial map information.

In some embodiments, the tracking method 600 further comprises the following steps: determining, by the central monitoring device, whether a first electronic device of the at least one electronic device loses tracking; in response to the first electronic device losing tracking, determining, by the central monitoring device, a current position of the first electronic device; and transmitting, by the central monitoring device, an auxiliary map data corresponding to the current position to the first electronic device.

In some embodiments, the tracking method 600 further comprises the following steps: selecting, by the first electronic device, an updated range map data from the spatial map information based on the auxiliary map data; loading, by the first electronic device, the updated range map data into the memory space of the first electronic device; and performing, by the first electronic device, the relocalization operation based on the updated range map data in the memory space.

In some embodiments, the tracking method 600 further comprises the following steps: tracking, by the central monitoring device, a current position of the at least one electronic device; and in response to the current position of a second electronic device being in a switching position of a first area, transmitting, by the central monitoring device, a switching position configuration corresponding to a second area to the second electronic device to make the second electronic device perform the relocalization operation based on the switching position configuration.

In some embodiments, the initial position configuration comprises at least one initial position, and a position coordinate, an initial orientation, and a loading range of each of the at least one initial position, and the tracking method 600 further comprises the following steps: calculating, by the central monitoring device, a device amount of the at least one electronic device located in a target area; and in response to the device amount being greater than a preset value, adjusting, by the central monitoring device, the loading range of each of the at least one initial position in the target area.

In some embodiments, the tracking method 600 further comprises the following steps: calculating, by the at least one electronic device, a device amount of the at least one electronic device located in a target range; and in response to the device amount being greater than a preset value, adjusting, by the at least one electronic device, the loading range.

In addition to the aforesaid steps, the second embodiment can also execute all the operations and steps of the tracking system 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

The tracking method described in the second embodiment may be implemented by a computer program having a plurality of codes. The computer program may be a file that can be transmitted over the network, or may be stored into a non-transitory computer readable storage medium. After the codes of the computer program are loaded into an electronic system (e.g., the tracking system 1), the computer program executes the tracking method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage medium with the same function and well known to those of ordinary skill in the art.

It shall be appreciated that in the specification and the claims of the present disclosure, some words (e.g., the initial position, the initial orientation, the character category, the electronic device, the area, etc.) are preceded by terms such as “first” and “second”, and these terms of “first” and “second” are only used to distinguish these different words. For example, the “first” and “second” character categories are only used to indicate the character categories used in different operations.

According to the above descriptions, the tracking technology (at least including the system and the method) provided by the present disclosure, by pre-defining the initial position configuration, the electronic device can select the range map data from the spatial map information to load the range map data into the memory space of the electronic device. Then, the electronic device performs a relocalization operation based on the range map data in the memory space. Since the present disclosure does not need to load all spatial map information into the memory, it solves the problem of memory resource burden in the prior art. In addition, since the content of map data that needs to be compared is reduced, the efficiency of relocalization operations and tracking operations can be improved. In addition, the tracking technology provided by the present disclosure can reduce the memory resource usage of the electronic device and improve the efficiency of resource utilization.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tracking system, comprising:
at least one electronic device, wherein each of the at least one electronic device is configured to store a spatial map information, and each of the at least one electronic device is configured to perform the following operations:
selecting a range map data from the spatial map information based on an initial position configuration, wherein the range map data is a part of the spatial map information;
loading the range map data into a memory space of the at least one electronic device;
performing a relocalization operation based on the range map data in the memory space; and
in response to completing the relocalization operation, initiating a tracking operation corresponding to the at least one electronic device.

2. The tracking system of claim 1, wherein the initial position configuration comprises at least one initial position, a position coordinate and a loading range of each of the at least one initial position, and the operation of selecting the range map data further comprises the following operations:
selecting the range map data from the spatial map information based on the position coordinate and the loading range of each of the at least one initial position.

3. The tracking system of claim 1, wherein the initial position configuration comprises at least one initial position, and a position coordinate, an initial orientation, and a loading range of each of the at least one initial position, and the operation of initiating the tracking operation corresponding to the at least one electronic device further comprises the following operations:
determining a first initial position from the at least one initial position based on a positioning information of the at least one electronic device; and
initiating the tracking operation corresponding to the at least one electronic device based on the position coordinate, the initial orientation, and the loading range of the first initial position.

4. The tracking system of claim 3, wherein the initial position configuration further comprises a plurality of character categories corresponding to each of the at least one initial position and a first initial orientation and a second initial orientation corresponding to the plurality of character categories, and each of the at least one electronic device further performs the following operations:
initiating the tracking operation based on the first initial orientation by the at least one electronic device corresponding to a first character category; and
initiating the tracking operation based on the second initial orientation by the at least one electronic device corresponding to a second character category;
wherein the first initial orientation is different from the second initial orientation.

5. The tracking system of claim 1, wherein the tracking system further comprises:
a central monitoring device, being communicatively connected to the at least one electronic device, wherein the central monitoring device is configured to monitor a tracking status of each of the at least one electronic device;
wherein each of the at least one electronic device further performs the following operations:
receiving the initial position configuration from the central monitoring device to select the range map data from the spatial map information.

6. The tracking system of claim 5, wherein the central monitoring device is further configured to perform the following operations:
determining whether a first electronic device of the at least one electronic device loses tracking;
in response to the first electronic device losing tracking, determining a current position of the first electronic device; and
transmitting an auxiliary map data corresponding to the current position to the first electronic device.

7. The tracking system of claim 6, wherein the first electronic device is further configured to perform the following operations:
selecting an updated range map data from the spatial map information based on the auxiliary map data;
loading the updated range map data into the memory space of the first electronic device; and
performing the relocalization operation based on the updated range map data in the memory space.

8. The tracking system of claim 5, wherein the central monitoring device is further configured to perform the following operations:
tracking a current position of the at least one electronic device; and
in response to the current position of a second electronic device being in a switching position of a first area, transmitting a switching position configuration corresponding to a second area to the second electronic device to make the second electronic device perform the relocalization operation based on the switching position configuration.

9. The tracking system of claim 5, wherein the initial position configuration comprises at least one initial position, and a position coordinate, an initial orientation, and a loading range of each of the at least one initial position, and the central monitoring device is further configured to perform the following operations:
calculating a device amount of the at least one electronic device located in a target area; and
in response to the device amount being greater than a preset value, adjusting the loading range of each of the at least one initial position in the target area.

10. The tracking system of claim 2, wherein each of the at least one electronic device is configured to perform the following operations:
calculating a device amount of the at least one electronic device located in a target range; and
in response to the device amount being greater than a preset value, adjusting the loading range.

11. A tracking method, being adapted for use in a tracking system, wherein the tracking system comprises at least one electronic device, each of the at least one electronic device is configured to store a spatial map information, and the tracking method comprises:
selecting, by the at least one electronic device, a range map data from the spatial map information based on an initial position configuration, wherein the range map data is a part of the spatial map information;
loading, by the at least one electronic device, the range map data into a memory space of the at least one electronic device;
performing, by the at least one electronic device, a relocalization operation based on the range map data in the memory space; and
in response to completing the relocalization operation, initiating, by the at least one electronic device, a tracking operation corresponding to the at least one electronic device.

12. The tracking method of claim 11, wherein the initial position configuration comprises at least one initial position, a position coordinate and a loading range of each of the at least one initial position, and the step of selecting the range map data further comprises the following steps:
selecting the range map data from the spatial map information based on the position coordinate and the loading range of each of the at least one initial position.

13. The tracking method of claim 11, wherein the initial position configuration comprises at least one initial position, and a position coordinate, an initial orientation, and a loading range of each of the at least one initial position, and the step of initiating the tracking operation corresponding to the at least one electronic device further comprises the following steps:
determining a first initial position from the at least one initial position based on a positioning information of the at least one electronic device; and
initiating the tracking operation corresponding to the at least one electronic device based on the position coordinate, the initial orientation, and the loading range of the first initial position.

14. The tracking method of claim 13, wherein the initial position configuration further comprises a plurality of character categories corresponding to each of the at least one initial position and a first initial orientation and a second initial orientation corresponding to the plurality of character categories, and the tracking method further comprises the following steps:
initiating the tracking operation based on the first initial orientation by the at least one electronic device corresponding to a first character category; and
initiating the tracking operation based on the second initial orientation by the at least one electronic device corresponding to a second character category;
wherein the first initial orientation is different from the second initial orientation.

15. The tracking method of claim 11, wherein the tracking system further comprises a central monitoring device, the central monitoring device is communicatively connected to the at least one electronic device, the central monitoring device is configured to monitor a tracking status of each of the at least one electronic device, and the tracking method further comprises the following steps:
receiving, by the at least one electronic device, the initial position configuration from the central monitoring device to select the range map data from the spatial map information.

16. The tracking method of claim 15, wherein the tracking method further comprises the following steps:
determining, by the central monitoring device, whether a first electronic device of the at least one electronic device loses tracking;
in response to the first electronic device losing tracking, determining, by the central monitoring device, a current position of the first electronic device; and
transmitting, by the central monitoring device, an auxiliary map data corresponding to the current position to the first electronic device.

17. The tracking method of claim 16, wherein the tracking method further comprises the following steps:
selecting, by the first electronic device, an updated range map data from the spatial map information based on the auxiliary map data;
loading, by the first electronic device, the updated range map data into the memory space of the first electronic device; and
performing, by the first electronic device, the relocalization operation based on the updated range map data in the memory space.

18. The tracking method of claim 15, wherein the tracking method further comprises the following steps:
tracking, by the central monitoring device, a current position of the at least one electronic device; and
in response to the current position of a second electronic device being in a switching position of a first area, transmitting, by the central monitoring device, a switching position configuration corresponding to a second area to the second electronic device to make the second electronic device perform the relocalization operation based on the switching position configuration.

19. The tracking method of claim 15, wherein the initial position configuration comprises at least one initial position, and a position coordinate, an initial orientation, and a loading range of each of the at least one initial position, and the tracking method further comprises the following steps:
calculating, by the central monitoring device, a device amount of the at least one electronic device located in a target area; and
in response to the device amount being greater than a preset value, adjusting, by the central monitoring device, the loading range of each of the at least one initial position in the target area.

20. The tracking method of claim 12, wherein the tracking method further comprises the following steps:
calculating, by the at least one electronic device, a device amount of the at least one electronic device located in a target range; and
in response to the device amount being greater than a preset value, adjusting, by the at least one electronic device, the loading range.
